(19) United States
(12) Patent Application Publication
(10) Pub. No.: US 2016/0122014 A1
(43) Pub. Date: May 5, 2016

(54) FLYING OBJECT OPERATING SYSTEM

(71) Applicant: Soo-Young JANG, Incheon (KR)

(72) Inventor: Soo-Young JANG, Incheon (KR)

(21) Appl. No.: 14/897,869

(22) PCT Filed: Jun. 3, 2014
(86) PCT No.: PCT/KR2014/004931

§ 371 Date: Dec. 11, 2015

(30) Foreign Application Priority Data
Jun. 19, 2013 (KR) 10-2013-0070109
Jul. 30, 2013 (KR) 10-2013-0090389

(51) Int. Cl. B64C 39/02; G01C 21/00; B64F 3/02; B64B 1/12; B64D 39/00

(52) U.S. Cl. CPC B64C 39/022; B64B 1/12; B64D 39/00; B64F 3/02; G01C 21/005

(57) ABSTRACT

The present invention relates to a system for operating a flying object that is flown from the ground. The flying object operation system includes a flying object that is filled with a gas therein to stay in the sky, a ground unit installed on the ground, a wire unit connecting the flying object to the ground unit, and a buoyancy-generation unit disposed on a side of the flying object to obtain buoyancy through friction with air, thereby transferring the obtained buoyancy to the flying object. In the present invention, since additional wind-derived buoyancy obtained by the buoyancy-generation unit connected to the flying object is further generated, sufficient buoyancy may be supplied to the flying object in a high-altitude environment to stably operate the flying object. Also, since power generated by using the wind power generation unit is transmitted to the ground through the wire unit, the flying object operation system may be utilized as wind power generation equipment.

### TECHNICAL FIELD

The present invention relates to a flying object, and in particular to a flying object operating system which is connected to the ground and is able to receive electric power from the ground and to stay flying at a predetermined position from the ground.

### BACKGROUND ART

In general, a flying object represents an object which is able to fly in the air and may be categorized into an airship which uses a self-generated power like an airplane and a non-power flying object like a glider.

A towing airship which is a representative of such a non-power flying object is a kind of a flying object which is configured to generate lift from gas in such a way to inject gas lighter than the air into an air sac.

In recent years, a new flying object is being widely used. As an example, the non-power flying object equips with an assistant power device, for example, an engine, etc. so as to generate a propelling force.

The above airship is able to maintain a parallel state without power, whereupon it is more stable than any other airplane and generates less noise and has a low fuel consumption ratio.

The above airship is being widely used for the sake of advertisements and sports broadcast, travels, transportation business and observation fields thanks to the natural features of the airship, namely, the stability, flying performance in the air and economic feasibility.

In addition, in recent years, as an information and communication field advances, researches are vividly underway to use stratosphere where communication and observation are more advantageous. The stratosphere is formed about 8˜10 km to about 50˜56 km above the ground of the earth and has a very stable weather condition as compared with the troposphere. For this reason, many various searches are underway to use such advantages. As one of such researches, an airship which is able to stay in the stratosphere is being researched together.

In other words, in the stratosphere, since the density of air is 1/14 as compared with the sea level, drag having effect on the airship is small. For this reason, it does not need to obtain a large propelling energy which may be used to keep a predetermined position. As compared with a satellite flying at a geostationary orbit of 3,6000 km, the stratosphere of 30 km is advantageous in the way that transmission delay and transmission loss are low, and a wideband high speed mobile communication/large capacity high speed communication/non-detection are available.

In addition, in the stratosphere, it is possible to obtain a higher resolution power than the satellite and a wider range image than the airplane, the stratosphere can be very usefully used in an earth observation and monitoring field.

In this way, the airship needs to carry out various missions while staying in the stratosphere or above 2 km above the ground which might be lower than the stratosphere. In case of such a high altitude, a severe environment exists, wherein density and temperature are much lower than on the ground. For this reason, a stable power is essential so as to operate the airship for a long time.

In addition, in order to carry out various missions, the airship should be supplied with a predetermined level of a stable electric power. For the sake of such stable power supply, a direct connection to the ground may be the best solution.

However, the electric power supply by means of such a connection to the ground may not be easy due to the natural characteristic of the airship since it should be fixed at a predetermined position in the air. Any solution to resolve this problem entails a huge cost.

In addition, enough buoyancy may not be provided to the airship due to low atmospheric pressure under such a high altitude environment. For this reason, there may be a limit to the weight of the airship itself which will be operated. It is hard to equip the airship with various devices.

In addition, in order to stably carry out various missions, for example, communication, observation, etc. in such a way to use the airship, it is essential to keep the position of the flying object within a designated zone, the research on which is currently underway.

The Korean patent publication number 10-2003-0043205 describes a technology to change the position of a flying object with the aid of an engine connected to a position control device and a propeller.

However, if the position of a flying object is controlled using a conventional driving device, the operation of such a device inevitably entails a lot of energy consumption, whereupon the efficiency during the operation of the flying object may be lowered, and a long time operation of the flying object may be impossible.

### DISCLOSURE OF INVENTION

### Technical Problem

Accordingly, the present invention is made in an effort to resolve the above problems. It is an object of the present invention to provide a flying object operating system which is able to provide stable power supply and power generation to a flying object which stays within a designated zone in the air.

In addition, it is another object of the present invention to provide a flying object operating system which may equip with a self-position control function in order for a flying object to operate within a designated zone.

In addition, it is further another object of the present invention to provide a flying object operating system which is able to save power used to keep the position of a flying object since the flying object can have enough buoyancy under a high altitude environment of a low atmospheric pressure.

In addition, it is still further another object of the present invention to provide a flying object operating system which may equip with a position control function wherein an environment friendly and long term operation are available in such a way to minimize the energy consumption which may occur due to the position control of the flying object.

### Technical Solution

To achieve the above objects, there is provided a flying object operating system wherein a flying object floating in the air above the ground is operated, which may include, but is not limited to, a flying object which is floating in the air; at least two or more ground units which are installed on the ground; and a wire unit which is provided for each ground unit, wherein one end of the wire unit is fixed at the ground unit, and the other end is fixed at the flying object, thus interconnecting the ground unit and the flying object, the ground units are installed spaced-apart from each other by a predetermined interval, and each of the ground unit and the wire unit are provided two in number, and each of the wire units separately includes two electric power cables.

In addition, to achieve the above objects, a flying object operating system wherein a flying object floating in the air above the ground is operated, which may include, but is not limited to, a flying object which is floating in the air; at least two or more ground units which are installed on the ground; and a wire unit which is provided for each ground unit, wherein one end of the wire unit is fixed at the ground unit, and the other end is fixed at the flying object, thus interconnecting the ground unit and the flying object, the ground units are installed spaced-apart from each other by a predetermined interval, and each of the ground unit and the wire unit are provided three in number, and each of the wire units separately includes an electric power cable and a ground cable.

In addition, to achieve the above objects, there is provided a flying object operating system wherein a flying object floating in the air above the ground is operated, which may include, but is not limited to, a flying object which is floating in the air; at least two or more ground units which are installed on the ground; and a wire unit which is provided for each ground unit, wherein one end of the wire unit is fixed at the ground unit, and the other end is fixed at the flying object, thus interconnecting the ground unit and the flying object, the ground units are installed spaced-apart from each other by a predetermined interval, and each of the ground unit and the wire unit are provided three in number, and each of the wire units separately includes three-phase electric power cables.

In addition, there is further provided a buoyancy-generation unit which is provided on one side of the flying object and is able to generate buoyancy with the aid of flow of gas and transfer the buoyancy to the flying object.

In addition, the buoyancy-generation unit may include a base unit which is fixed on one side of the flying object; at least one or more connection cable which is fixed at the base unit; and a friction unit which is connected with the connection cable and has a friction with air and is able to generate buoyancy while separating from the flying object.

In addition, the flying object comprises a plurality of the buoyancy-generation units, and as a part of a plurality of the buoyancy-generation units operates, the direction of the buoyancy generated by the buoyancy-generation unit is adjusted.

In addition, the connection cable of the buoyancy-generation unit is provided multiple in number, and a winder is provided at an end of each connection cable, thus adjusting the length of each connection cable, and the direction of friction with air in the friction unit can be adjusted by adjusting the length of at least a part of a plurality of the connection cables.

In addition, the connection cable is configured in such a way to adjust the length of the connection cable, and the height where the friction unit is floating from the flying object can be adjusted using the connection cable, thus selectively driving the buoyancy-generation unit.

In addition, the friction unit of the buoyancy-generation unit is provided multiple in number, and a plurality of the friction units are provided in a row on the tops of the closely neighboring other friction units.

In addition, the flying object operates at an altitude of 2 km˜12 km.

In addition, the flying object further comprises a wind power generation unit which is able to generate electric power through friction with air.

In addition, the wind power generation unit may include a main body which is provided on one side of the flying object and includes a power generation unit in its inside; and a blade which is provided at an end of a fixing unit and rotates during the friction with air.

In addition, the wind power generation unit is provided rotatable on the flying object, whereupon the friction angle between the blade and air can be adjusted.

In addition, the flying object includes a sensor which is able to measure the angle of friction with air and wind power.

Meanwhile, the wire unit may include an electric power wire for electrically connecting the flying object and the ground unit; and a fixing wire which extends together with the electric power wire and is able to prevent the flying object from separating by over a predetermined distance from the ground unit with the aid of tensional force.

In addition, the ground unit may include a main ground; and a sub-ground which is installed spaced apart from the main ground and is installed on at least one or more position of the ground, wherein an electric power supply unit is provided at either the main ground or the sub-ground so as to supply electric power to the flying object.

In addition, the ground unit may include a main ground; and a pair of sub-grounds which are spaced apart from the main ground, wherein the main ground and a pair of the sub-grounds are installed at a vertex of a virtually drawn regular triangle or an isosceles triangle.

In addition, the wire unit includes an observation device, and the observation device is arranged movable along the wire unit.

In addition, the ground unit includes a winder device to adjust the tension of the wire unit.

Meanwhile, to achieve the above objects, there is provided a flying object operating system which is directed to operating a flying object so as to carry out a communication relay function or an observation function in such a way to maintain a floating state within a designated zone above the ground, which may include, but is not limited to, a flying object which is floating in the air; a ground unit which is installed on the ground; and a wire unit one end of which is fixed at the ground unit and the other end of which is fixed on the flying object while interconnecting the ground unit and the flying object, wherein the flying object includes a horizontal wing which is arranged rotatable with respect to the flying object and allows the flying object to stay within a designated zone by changing the upward and downward resistances with respect to the wind of the flying object if the flying object deviates out of the designated zone in the upward and downward directions;

a vertical wing which is arranged rotatable with respect to the flying object and allows the flying object to stay within the designated zone by changing the leftward and rightward resistances with respect to the wind of the flying object if the flying object deviates out of the designated zone in the horizontal direction; and a control unit which detects the position of the flying object and is able to control the rotations of the horizontal wing and the vertical wing in accordance with the detected position.

At this time, the control unit may include a GPS module for detecting the position of the flying object; and a driving controller which is configured to drive any one of the horizontal wing and the vertical wing by determining whether or not the detection position of the GPS module is within the set designated zone and the separating direction and distance from the designated zone.

In addition, the control unit is configured to recognize the position of the flying object from the position information which is observed on the ground and is transmitted thereto.

In addition, the control unit includes an observation unit for observing a topography and facilities on the ground; and a position calculation unit which is able to calculate the position of the flying object based on a result of the observation carried out by the observation unit.

In addition, the control unit further includes a radar measurement unit, and the position calculation unit calculates the position of the flying object based on a result of the observation by the observation unit and a result of the measurement by the radar measurement unit.

In addition, the control unit further includes a laser measurement unit, and the position calculation unit calculates the position of the flying object based on a result of the observation by the observation unit and a result of the measurement by the laser measurement unit.

In addition, to achieve the above objects, there is provided a flying object operation system which is directed to operating a flying object which is floating above the ground, which may include, but is not limited to, a flying object which is floated in the air; a ground unit which is installed on the ground; a wire unit one end of which is fixed at the ground unit, and the other end of which is fixed on the flying object, thus interconnecting the ground unit and the flying object; and a buoyancy-generation unit which is provided on one side of the flying object and is able to generate buoyancy with the aid of the flow of gas and transfer the buoyancy to the flying object, wherein the buoyancy-generation unit comprises a friction unit which has a friction with air and separates from the flying object, thus generating buoyancy; a plurality of connection cables one end of each of which is connected with the friction unit; and a base unit which is provided on one side of the flying object for the other end of each of the connection cables to be fixed, thus adjusting the lengths of the connection cables.

Here, the flying object further includes a control unit which is configured to detect the position of the flying object and control the base unit to adjust the lengths of the connection cables based on the detected position.

Meanwhile, to achieve the above objects, there is provided a flying object operation system which is directed to operating a flying object which is floating above the ground, which may include, but is not limited to, a flying object which is floated in the air; a ground unit which is installed on the ground; a wire unit one end of which is fixed at the ground unit; a plurality of adjusting wires one end of each of which is fixed at the other end of the wire unit, and the other end of each of which is fixed at the flying object; and a driving engaging unit which is provided on one side of the flying object and is engaged with the adjusting wire, thus fixing the adjusting wire at the flying object in such a way that the length of the adjusting wire is adjustable, wherein the flying object includes a horizontal wing and a vertical wing which are provided in the horizontal and vertical directions of the flying object.

At this time, the flying object further comprises a control unit which detects the position of the flying object and controls the driving engaging unit so as to adjust the length of the adjusting wire based on the detected position.

In addition, the driving engaging unit is installed four in number at the left, back, left and right sides of the flying object.

In addition, the designated zone is a limited range of the position of the flying object so as to stably carry out the function of the flying object.

In addition, the flying object comprises at least or more solar panel or wind power generation unit so as to self-generate power which will be used when operating the flying object.

In addition, the wire unit includes an electric power cable and a ground cable for supplying electric power to the flying object.

Meanwhile, the ground unit is provided multiple in number which are spaced apart from each other at regular intervals, and the wire unit includes either the electric cable or the ground cable.

In addition, each of the ground unit and the wire unit is provided two in number, and each of the wire units separately includes two electric power cables.

In addition, each of the ground unit and the wire unit is provided three in number, and each of the wire units separately includes an electric power cable and a ground cable.

In addition, each of the ground unit and the wire unit is three in number, and each of the wire units separately includes three-phase electric power cables.

### Advantageous Effects

As mentioned above, the flying object operating system according to the present invention may have the following effects.

In other words, the present invention provides a flying object operating system which equips with a self-position detection function and a position control function, whereupon a flying object designed to perform a given mission at a fixed position can obtain stability when carrying out a corresponding mission.

In addition, in the present invention, since a position control of a flying object can be carried out with less power, energy efficiency during the operation of a flying object can be maximized. If a flying object equips with the function of a wind power generation or a solar power generation, a position control of the flying object may be available only with self-generating power.

In addition, in the present invention, more buoyancy can be generated using wind which may be generated by a buoyancy-generation unit connected to an airship, with the aid of which it is possible to carry out a position control of the flying object, while obtaining a sable operation of the flying object. Since the buoyancy of the flying object can be appropriately maintained by adjusting the buoyancy-generation unit connected to the airship, more stable operation is available.

In addition, since a wire unit interconnects the flying object staying at a high altitude and a ground unit, the flying object can stay at a set position without a separately supplied driving source. To this end, various missions can be easily carried out, and any maintenance cost for the flying object can decrease, thus enhancing economic feasibility.

In addition, in the present invention, the flying object is connected through the wire unit to the ground units which are installed at least three or more points, so various missions can be carried using high voltage power supplied from the same.

Since the ground units are installed spaced-apart from each other, any short-circuit due to interference between the wire units can be prevented, thus rendering the coating look simplified, and the durability and stability can be enhanced, while obtaining enhanced economic feasibility.

In addition, if the flying object operating system is formed of at least two or more ground units, since they are arranged enough spaced-apart, any electric power leakage possibility is low, whereupon a relatively high electric voltage can be supplied.

In addition, in the present invention, the airship may further equip with a wind power generation unit. This wind power generation unit can generate electric power using the friction with air, so it is possible to self-obtain electric power which may be used in the operations of the flying object.

Of course, since the electric power generated using the wind power generation unit can be supplied to the ground through the wire unit, it can be used for any wind power generating facility.

### BRIEF DESCRIPTION OF DRAWINGS

FIG. 1 is a schematic view illustrating a configuration of a flying object operating system according to an exemplary embodiment of the present invention.

FIGS. 2A to 2C are example views illustrating a configuration of a ground unit according to an exemplary embodiment of the present invention.

FIG. 3 is a view illustrating a state where a buoyancy-generation unit is exploded according to an exemplary embodiment of the present invention.

FIG. 4 is a view illustrating a configuration wherein the angle of a buoyancy-generation unit is changed according to an exemplary embodiment of the present invention.

FIG. 5 is a perspective view illustrating key components in a configuration formed of a rotation socket and a wire unit according to an exemplary embodiment of the present invention.

FIG. 6 is a schematic view illustrating a configuration of a flying object operating system according to a second exemplary embodiment of the present invention.

FIG. 7 is a schematic view illustrating a configuration of a flying object operating system according to a third exemplary embodiment of the present invention.

FIG. 8 is an example view illustrating a configuration wherein the angle of a wind power generation unit of the exemplary embodiment in FIG. 7.

FIG. 9 is a schematic view illustrating a configuration of a flying object operating system according to a fourth exemplary embodiment of the present invention.

FIG. 10 is a schematic view illustrating a configuration of a flying object operating system according to a fifth exemplary embodiment of the present invention.

FIG. 11 is a schematic view illustrating a configuration of a flying object operating system according to a sixth exemplary embodiment of the present invention.

FIG. 12 is a schematic view illustrating a configuration of a flying object operating system according to a seventh exemplary embodiment of the present invention.

FIG. 13 is a schematic view illustrating a configuration of a flying object operating system according to an eighth exemplary embodiment of the present invention.

FIG. 14 is an example view illustrating an operation state of a position control of a flying object operating system according to an eighth exemplary embodiment of the present invention.

FIG. 15 is an example view illustrating an operation state of a position control of a flying object operating system as another example according to an eighth exemplary embodiment of the present invention.

FIG. 16 is a schematic view illustrating a configuration of a flying object operating system according to a ninth exemplary embodiment of the present invention.

FIG. 17 is an example view illustrating an operation state of a buoyancy-generation unit of a flying object operating system according to a ninth embodiment of the present invention.

FIG. 18 is a schematic view illustrating a configuration of a flying object operating system according to a tenth exemplary embodiment of the present invention.

FIG. 19 is an example view illustrating an operation state of a position control of a flying object operating system according to a tenth exemplary embodiment of the present invention.

### BEST MODES FOR CARRYING OUT THE INVENTION

The flying object operating system according to the exemplary embodiments of the present invention will be described in detail with reference to the accompanying drawings.

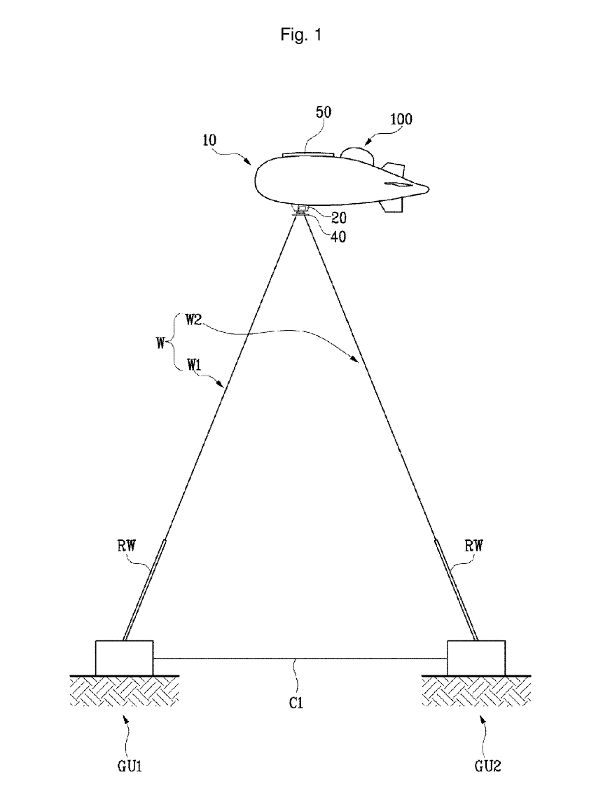

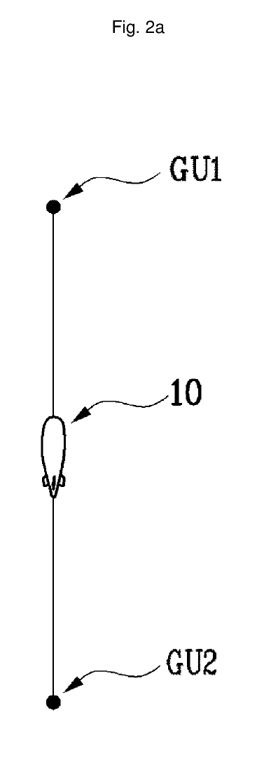

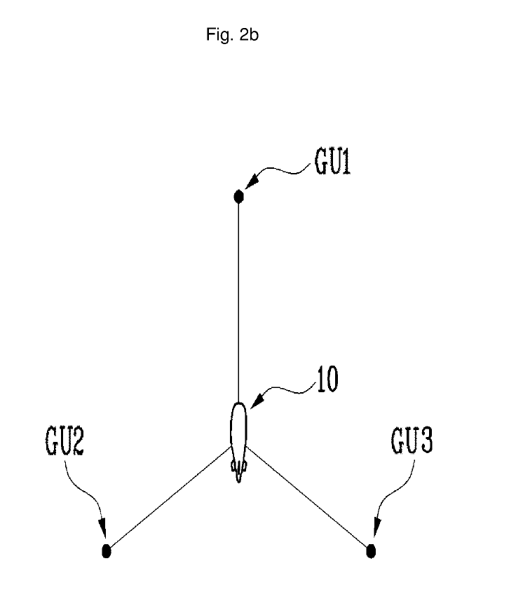

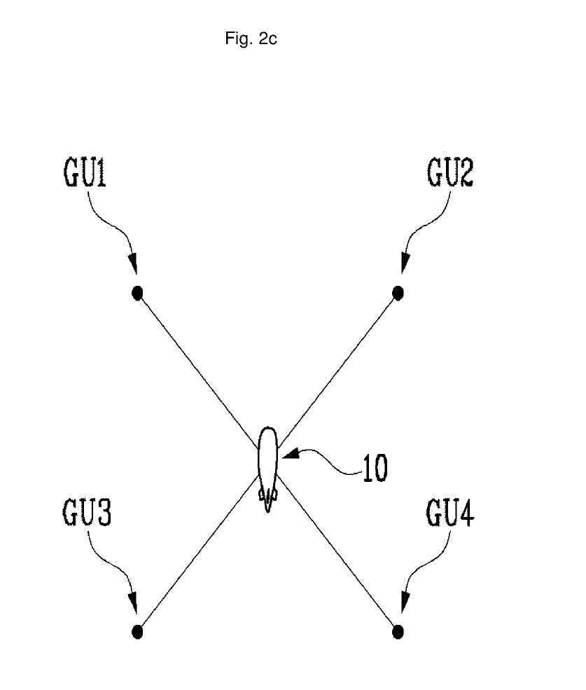

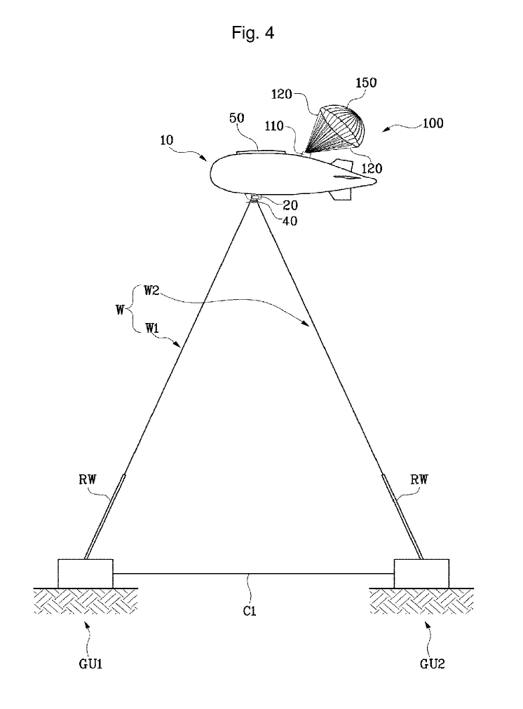

FIG. 1 is a schematic view illustrating a configuration of a flying object operating system according to an exemplary embodiment of the present invention. FIGS. 2A to 2C are example views illustrating a configuration of a ground unit according to an exemplary embodiment of the present invention. FIG. 4 is a view illustrating a configuration wherein the angle of a buoyancy-generation unit is changed according to an exemplary embodiment of the present invention.

To this end, the flying object operating system according to the present invention may include, but is not limited to, a flying object 10; ground units GU1 and GU2, and a wire unit “W”, the configuration of each of which will be described in order.

First, the flying object 10 is provided so as to carry out various missions while staying in the stratosphere and may be formed of a non-power flying object or various types of flying objects wherein a non-power flying object equips with an assistant power device.

The occasion where the flying object is an airship will be described as a representative example for easier understandings.

The flying object 10 can be used flying in the air for a long time since it can fly with the aid of an air sac filled with a gas, so various missions, for example, observation, etc. can be economically carried out. The gas filled in the air sac of the flying object 10 may be various kinds of gases which are lighter than helium gas.

On a lower side of the flying object 10, there may be provided an operation unit 20 formed of a propeller which is able to operate the flying object 10 or a sensor, etc. for measuring the pressure in the inside of the air sac. The operation unit 20 may equip with various kinds of measuring equipment for the sake of missions using the propeller as well as the flying object 10.

A rotation socket 40 may be provided on a lower side of the flying object 10. As illustrated in FIG. 4, the rotation socket 40 is arranged rotatable on the flying object 10. The rotation socket 40 is able to separate and fix an end of each of a plurality of wire units “W” while preventing the wire units “W” from getting entangled which may occur because of the rotations of the flying object 10.

The rotation socket 40 may include a through hole 42 for the sake of engagement with a rotary shaft (not illustrated), and a plurality of wire holes 43 are formed around the through hole 42, so the wire holes 43 may be formed extending up to the operation unit 20.

A solar panel 50 is provided on the top of the flying object 10. The solar panel 50 is for the sake of concentration of solar heat, whereupon it is possible to self-generate part of the power which may be used for the operations of the flying object 10. The device for controlling the solar panel 50 may be installed on the operation unit 20.

Since missions, for example, weather observation, etc. is advantageous when the flying object 10 stays at a predetermined position in the stratosphere, it is important to fix the position of the flying object 10 within a designated zone, and it is necessary to stably supply the power (electric power) which may be used to carry out the missions of the flying object 10. The ground unit and the wire unit “W” are able to stably support the flying object 10 while providing stable power as mentioned above, the configuration and function of which will be described in detail below.

At this time, preferably, the flying object 10 is designed to fly above the ground and to stay at a high altitude. More specifically, it may operate at the altitude of 2 km-12 km. Particularly, if the flying object 10 operates at near 11 km, it may efficiently receive buoyancy with the aid of westerlies. However, the flying object 10 may be operable at various altitudes in accordance with the operation purpose and type of the flying object 10.

Next, the ground unit will be described. The ground unit is installed on the ground and is able to maintain the position of the flying object 10 and is configured to receive the data obtained through observation by the flying object 10. According to situations, the ground unit may serve to supply electric power to the flying object 10. For this, the ground unit may be connected with the flying object 10 through a wire unit “W”.

The ground unit may be provided one or multiple in number. If the ground unit is provided one in number, the position of the flying object 10 may be limited to a designated zone. In order to more stably maintain the position, it is preferred that a plurality of wire units are provided as follows.

FIG. 1 shows an example wherein the ground unit is provided two in number. As illustrated therein, the ground unit may be formed of a main ground GU1 and a sub-ground GU2. The sub-ground GU2 is installed spaced-apart from the main ground GU1.

In other words, the main ground GU1 and the sub-ground GU2 are installed enough spaced apart from each other, so the position of the flying object 10 can be determined at the center portion thereof. An electric power supply unit may be provided at either the main ground GU1 or the sub-ground GU2 so as to supply electric power to the flying object 10. The above electric power supply unit is able to supply electric power to the flying object 10 through the wire unit “W”.

Of course, the electric power which has been accumulated through the wind power generation unit 300 of the flying object 10 may be transferred through the wire unit “W” to the main ground GU1 or the sub-ground GU2.

At this time, since the main ground GU1 and the sub-ground GU2 can be installed spaced apart with an interval of 2˜3 km or more between them, even though electric power supply is carried out through the wire unit “W” from the main ground GU1 and the sub-ground GU2, any interference and short-circuit can be prevented between them.

In particular, if two ground units are provided, since they are enough spaced apart from each other, any power leakage possibility may be reduced, whereupon it is possible to supply a large voltage (high voltage of over hundreds or tens of thousands of volts) to each of the wire units W1 and W2. Consequently, it means that the coating thicknesses of the wire units W1 and W2 can be made relatively thinner.

More specifically, at a position which is near the ground, the wire units W1 and W2 may remain far due to the ground units which are spaced apart far from each other, and at a position which is near the flying object, even though the two wire units W1 and W2 become close to each other, any power leakage possibility is very low because of the natural environment in the stratosphere where humidity is low, whereupon stable power supply can be available.

The main ground GU1 forming the ground unit may include a control unit, a data unit, and an electric power supply unit. Into the data unit, any of the data of the sub-ground GU2, the data of the flying object 10 and the data observed by the flying object 10 may be stored. The electric power supply unit is able to supply electric power to the flying object 10.

The wire units and the ground units are configured in pairs. The above wire units may be provided two, three or more in number.

At this time, electric power may be supplied to the flying object 10 via various configurations in accordance with the number of the wire units. For example, if the wire units are two in number, each of the wire units may be configured in such a way that two electric power cables configured to supply DC or AC are separately included in each of the wire units.

Different from the above, if the wire units are three in number, each of the wire units may be configured in such a way that two electric power cables configured to supply DC or AC and one ground cable may be included in the wire unit. For the sake of supply of 3-phase electric power, three electric cables may be separately included in each of the wire units.

Meanwhile, if the wire units are three in number, each of the wire units may be configured in such a way that two electric cables configured to supply DC or AC and one communication cable for the sake of communication with the ground may be separately included in each of the wire units.

In this way, if the number of the wire units increases, conductive lines which may be used for electric power supply and communication are separately disposed at each of the wire units, whereupon a stable and economic application of the wire units is available.

Meanwhile, if the wire units are more than three in number, the ground units are provided on the ground in accordance with such a configuration. It is a basic purpose that the wire units maintain the flying object 10 at a stable position. Fort this, it is preferred that the wire units are installed spaced apart from each other in stable forms.

Therefore, as illustrated in FIGS. 2A to 2C, it is preferred that the ground units are arranged in a regular polygonal shape if the installation condition on the ground is available. If the ground units are two in number, they are installed relatively more spaced apart from each other, and if the ground units are three in number, they are installed spaced apart from each other in a triangle shape, and if the ground units are four in number, they are installed space apart from each other in a square shape.

Meanwhile, the main ground GU1 may further include a driving source. The driving source may allow to control a winder device for the sake of length adjustment of the wire unit “W”. The winder device is provided to adjust the tension of the wire unit “W”. The wire unit “W” may carry out a winding operation or an unwinding operation through which tension can be adjusted.

As not illustrated in the drawings, the ground unit may include a main ground GU1 and a pair of sub-grounds which are spaced apart from the main ground GU1. The main ground and a pair of the sub-grounds may be installed at a vertex of a virtually drawn triangle, preferably, at a vertex of a regular triangle or an isosceles triangle.

To this end, the flying object 10 can position at a portion corresponding to the center of the virtually drawn triangle formed by the ground units or the center of the isosceles triangle, by which it is possible to prevent the flying object 10 from deviating over a designated zone due to the tensional force of the three wire units “W” connecting the ground unit and the flying object 10.

The ground unit may store the information on the tensional force and tension lengths of a plurality of the wire units “W” connecting the flying object 10 and a plurality of the ground units. These information may be used to maintain the position of the flying object 10. The detailed operations of the three wire units “W” may be describes again below.

The non-described reference character C1 means a connection cable connecting the ground units. The connection cable C1 is able to transfer electric power or transmit data between them.

Next, the wire units “W” will be described. The wire unit “W” may include an electric power wire 80 for electrically connecting the flying object 10 and the ground unit; and a fixing wire 70 which extends together with the electric power wire 80.

The fixing wire 70 may serve to prevent the flying object 10 from separating by over a predetermined distance from the ground unit with the aid of tensional force. In the present embodiment of the present invention, it is formed of multiple strands of a high strength fiber material. It is obvious that the fixing wire 70 may be made of a fiber material including a glass reinforced fiber or its synthetic fiber or may be made of various materials.

The fixing wire 70 has over 900% in terms of its weight-to-tensional strength. For example, if the fixing wire 70 having a diameter of 0.5 mm extends up to 20 km, about 45 kg to 75 kg of tensional strength may be provided to the flying object 10, whereupon the flying object 10 can be fixed within an enough range of buoyancy.

As not illustrated in the drawings, the wire unit “W” may equip with a current sensor unit. The current sensor unit may be intermittently provided multiple in number on the lengthwise direction of the wire unit “W”, thus carrying out a function to detect any short-circuit of the wire unit “W”. If the wire unit “W” having a very long length is short-circuit, the position of the short-circuit can be easily found out.

In addition, it is preferred that a reinforcing cover may be provided near at least a partial portion of the ground unit of the wire unit “W” in order to reinforce the strength of the wire unit “W” or the wire unit “W” may be configured in such a way that its thickness thickens, the configuration of which is designed to prevent any damage to the wire unit “W” due to collision with birds, etc.

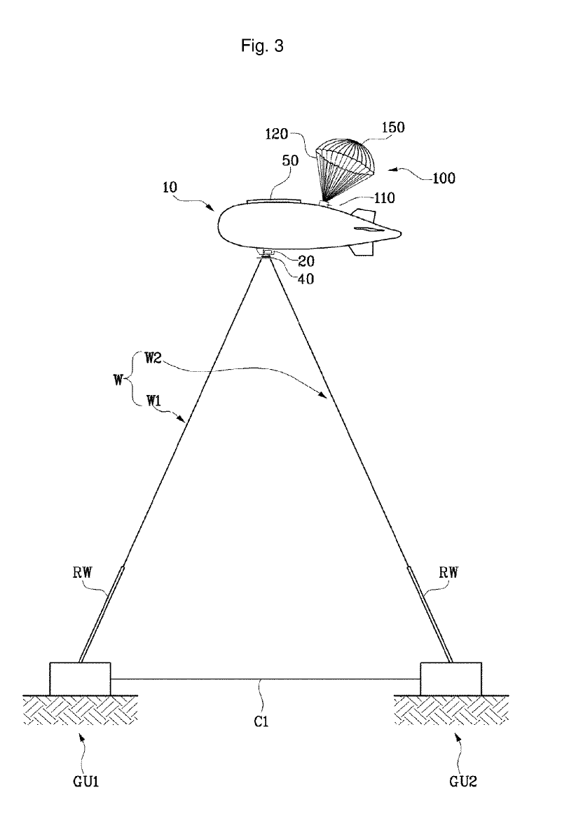

The flying object 10 may include a buoyancy-generation unit 100. The above buoyancy-generation unit 100 may be provided on one side of the flying object 10 and is able to generate buoyancy with the aid of friction with air. As illustrated in FIG. 3, it may be formed in a parachute structure which helps generate any friction with air.

More specifically, the buoyancy-generation unit 100 may include, but is not limited to, a base unit 110 fixed on one side of the flying object 10; at least one connection cable 120 one end of which is fixed at the base unit 110; and a friction unit 150 which is connected to the connection cable 120 and makes a friction with air and then separates from the flying object, thus generating buoyancy. As not illustrated in the drawings, the friction unit 150 may equip with a plurality of cells so as to prevent the connection cable 120 from being cut by over buoyancy which applies to the friction unit 150.

The flying object 10 may include a plurality of buoyancy-generation units 100. As a part of a plurality of the buoyancy-generation units 100 operates, the direction of the buoyancy generating by the buoyancy-generation unit 100 can be adjusted.

The connection cable 120 of the buoyancy-generation unit 100 may be provided multiple in number, and a winder (not illustrated) is provided at an end of each of a plurality of the connection cables 120, so the lengths of the connection cables 120 can be adjusted. In the friction unit 150, the direction that it has a friction with air can be adjusted in such a way to adjust the length of a part of a plurality of the connection cables 120.

In addition, the height that the friction unit 150 floats from the flying object can be adjusted by adjusting the lengths of the connection cables 120, thus selectively driving the buoyancy-generation unit 100. As illustrated in FIG. 1, the friction unit 150 is forced to very closely contact with the flying object 10 in such a way to fully wind the connection cable 120, thus inhibiting the operation of the buoyancy generating function.

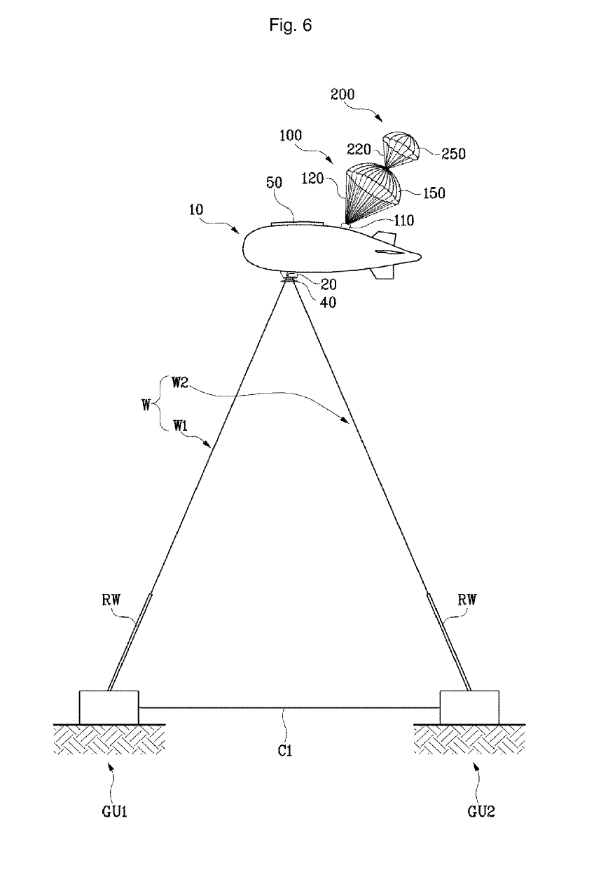

Meanwhile, as illustrated in FIG. 6, the friction unit 150 of the buoyancy-generation unit 100 may be provided multiple in number, and a plurality of the friction units 150 may be provided in a row on the top of the closely neighboring other friction units 150. In this way, the buoyancy by the buoyancy-generation unit 100 can be more increased.

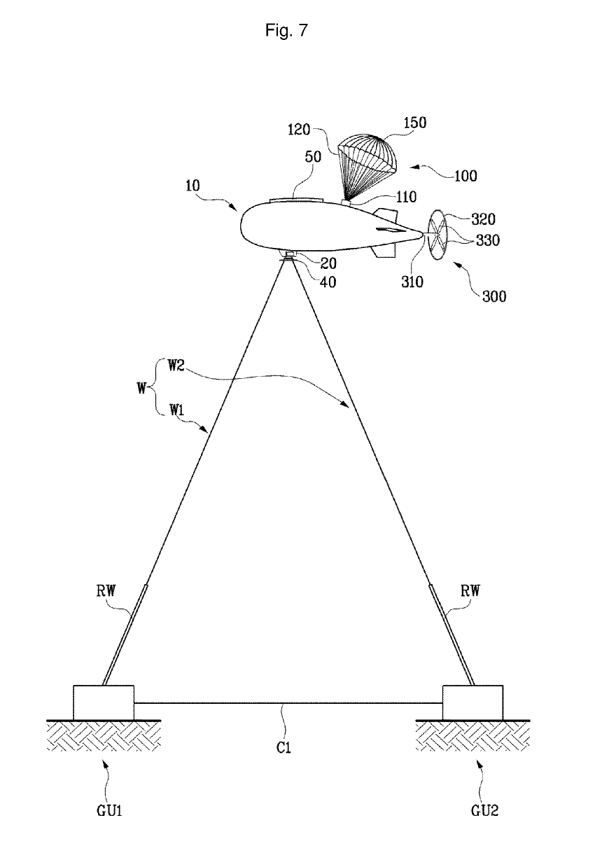

FIG. 7 is a view illustrating an example where the wind power generation unit 300 is disposed at the flying object 10. The wind power generation unit 300 is able to generate electric power through the friction with air and may be installed on the flying object 10 and may rotate by using the wind as a driving source, while converting the rotational force into the form of electric power.

More specifically, the wind power generation unit 300 may include a main body 310 which is disposed on one side of the flying object 10 and has an electric power generation unit in its inside; and a blade 330 which is disposed at an end of the fixing unit and rotates during friction with air.

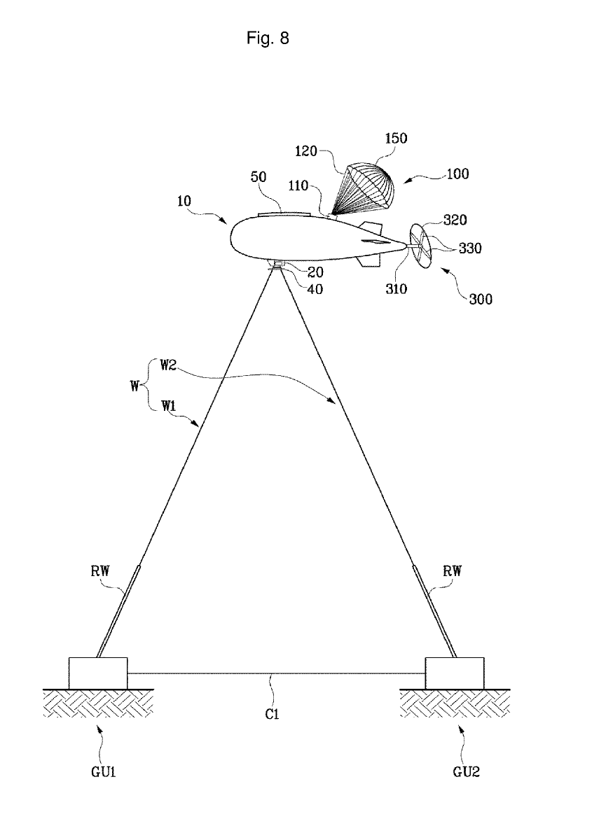

Here, the wind power generation unit 300 is disposed rotatable on the flying object. The friction angle between the blade 330 and air can be adjusted. FIG. 8 shows a state where the angle of the wind power generation unit 300 has changed.

More preferably, the flying object 10 may include a sensor (not illustrated) to measure the angle of friction with air and the wind power. Effective operation is available so that the blade 330 can rotate more strongly by changing the angle of the wind power generation unit 300 based on the friction angle with air, wind power, etc.

The right of the present invention is not limited to the above exemplary embodiments, but may be defined by the claims, and it is obvious that a person having ordinary skill in the art might change and modify the present invention within the scope of the rights defined in the claims.

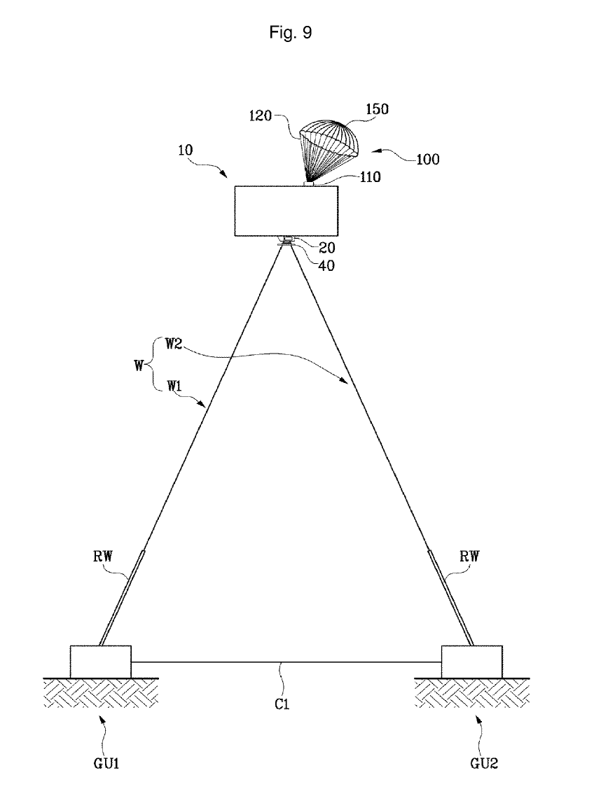

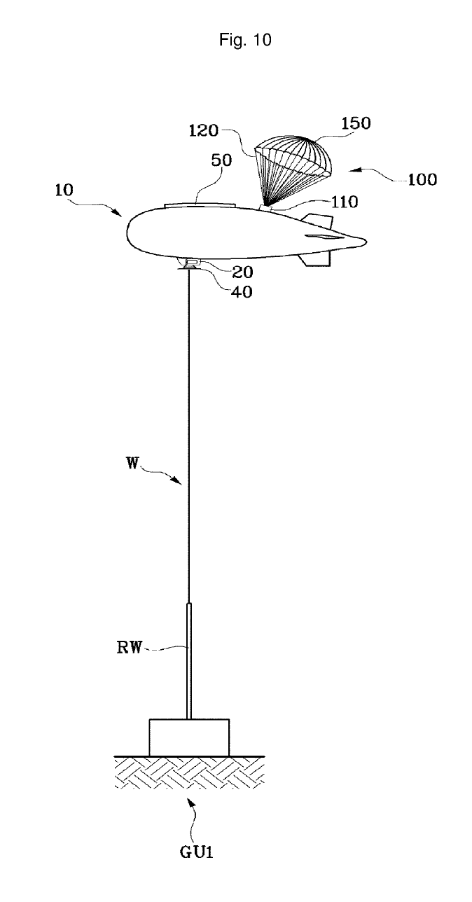

For example, it is not necessary for the gas to be filled in the inside of the flying object 10. The buoyancy may be received with the aid of the buoyancy-generation unit 100. In this case, as illustrated in FIG. 9, the flying object 10 may be changed into various shapes.

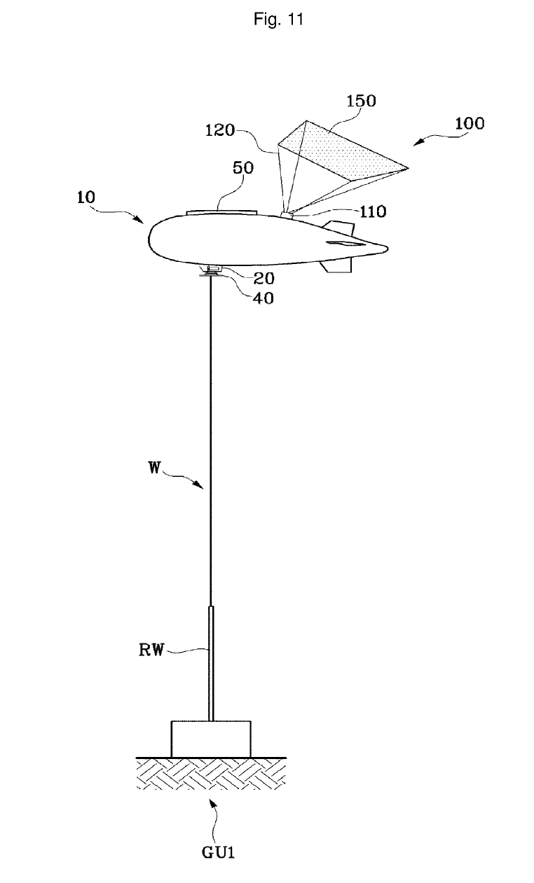

In addition, the friction unit 150 of the buoyancy-generation unit 100 may be configured to have enough friction with air. For example, as illustrated in FIG. 11, the friction unit 150 thereof may be transformed into various shapes including a kite structure to obtain lift with the aid of the flow of gas.

In addition, as illustrated in FIG. 11, it is not necessary to provide multiple ground units. One ground unit GU1 and the flying object 10 may be connected with each other.

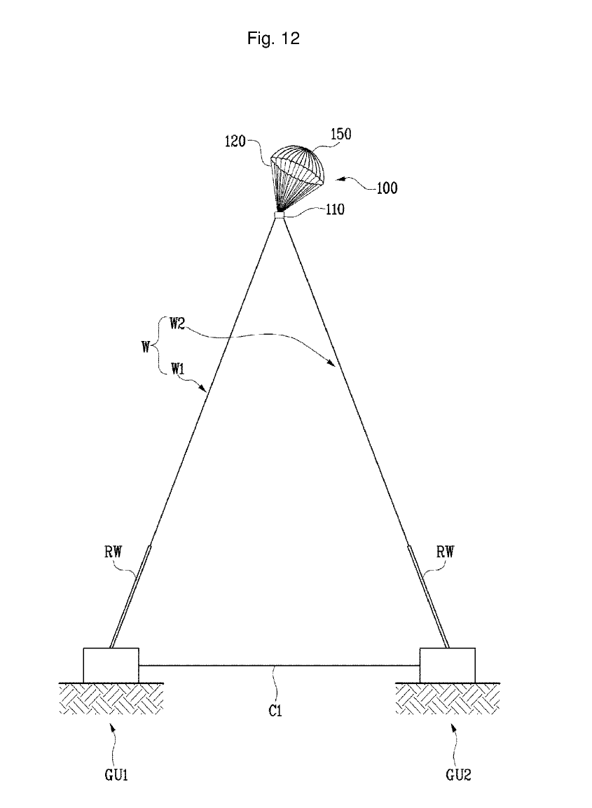

In addition, as illustrated in FIG. 12, the flying object 100 itself may be formed in a buoyancy-generation unit structure. In this case, the flying object 100 does not have an air sac structure into the inside of which gas is filled, but the flying object 100 itself may be formed in a parachute structure or a kite structure to have buoyancy. To this end, the flying object 100 is able to maintain a state where it is floated in the air by generating buoyancy with the aid of the flow of air. In this case, the flying object 100 may include a plurality of friction units which are able to generate buoyancy as they make friction with air. As a part of the friction units selectively operates, the direction of the buoyancy generating by the friction units can be adjusted.

### Modes for Carrying Out the Invention

The detailed exemplary embodiments in relation with the position control function of the flying object operating system according to the present invention will be described with reference to the accompanying drawings.

First, the configuration and function of the flying object operating system according to an eighth exemplary embodiment of the present invention will be described.

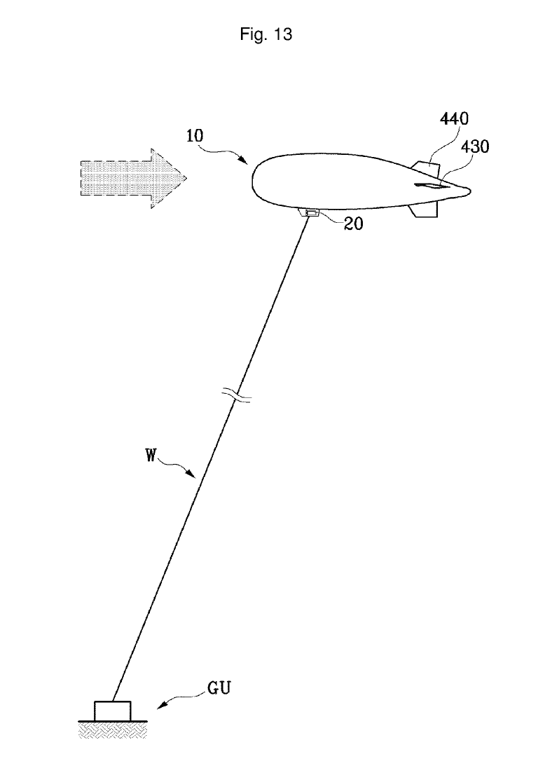

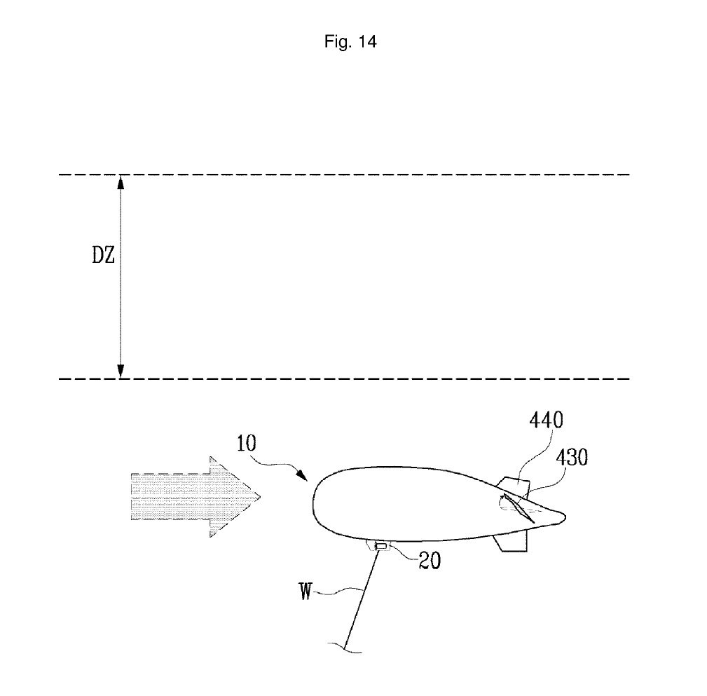

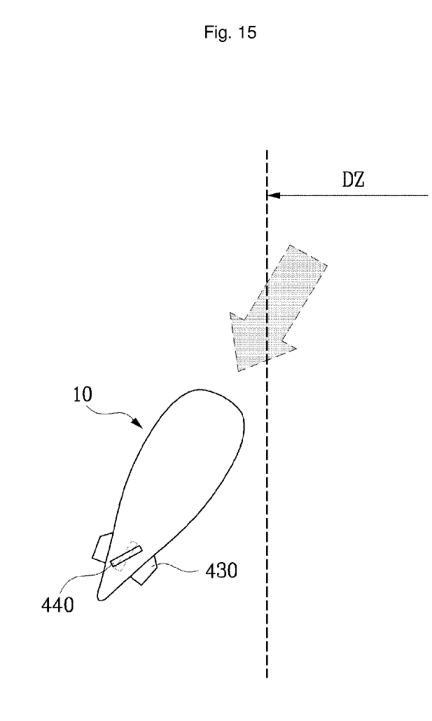

FIG. 13 is a schematic view illustrating a configuration of a flying object operating system according to an eighth exemplary embodiment of the present invention. FIG. 14 is an example view illustrating an operation state of a position control of a flying object operating system according to an eighth exemplary embodiment of the present invention. FIG. 15 is an example view illustrating an operation state of a position control of a flying object operating system as another example according to an eighth exemplary embodiment of the present invention.

As illustrated in the above drawings, the flying object operating system according to an eighth exemplary embodiment of the present invention may include, but is not limited to, a flying object 10; a ground unit GU an a wire unit “W”.

First, the flying object 10 is provided so as to carry out various missions while staying in the air at a high altitude. For this, a non-power flying object or various types of flying objects wherein an assistant power device is provided at the non-power flying object may be used.

Here, the high altitude sky is not limited to the altitude. Since the efficiency of the position control function according to the present invention may be maximized if a constant wind direction is maintained, the high altitude sky may preferably the upper area of the troposphere and the stratosphere where a prevailing wind, for example, westerlies, easterlies and trade wind is always present.

The occasion that the flying object is an airship hereinafter will be described as a representative example for easier understandings.

The flying object 10 may be used for a long time since it can be floated into the air with the aid of air sac filled with gas, so the flying object 10 can be economically used for the sake of various missions, for example, an observation, etc. The gas filled in the air sac of the flying object 10 may be various kinds of gases, for example, helium, etc. which are lighter than air.

On a lower side of the flying object 10, there may be provided an operation unit 20 which includes any devices for measuring the position of the flying object 10 and for controlling the position thereof, a sensor for measuring the pressure inside the air sac, etc. In addition, the operation unit 20 may include a transceiver device and a measuring device which will be used to carry out missions using the flying object 10.

More specifically, the operation unit 20 may equip with a control unit for controlling the position of the flying object 10. The control unit may include a GPS module for recognizing the position of the flying object and a driving controller and may store a limiting zone with respect to the position of the flying object.

Meanwhile, a solar panel (not illustrated) may be provided on an outer side of the flying object 10 in order to generate a self-power. The solar panel is provided for the sake of concentration of solar heat, thus self-supplying part of the power which is used for the operation of the flying object 10. In addition, the device for controlling the solar panel may be installed at the operation unit 20.

In addition, a wind power generation unit (not illustrated) may be provided on an outer side of the flying object 10 so as to generate self-power, thus more stably obtaining power source which will be used for the operation of the flying object 10.

The mission, for example, weather observation, may be advantageously carried out in case where the flying object 10 stays at a predetermined position in the stratosphere. For this reason, it is important to fix the position of the flying object 10 within a designated zone. It is also necessary to stably supply the power (electric power) so as to carry out the mission of the flying object 10.

The ground unit GU and the wire unit “W” are able to stably support the flying object 10 while providing stable power as mentioned above, the configuration and function of which will be described in detail below.

At this time, preferably, the flying object 10 is floated from the ground and may be operated to stay at a high altitude. More specifically, it may be operated at an altitude of 2 km˜12 km. Particularly, if the flying object 10 is operate at near 11 km, buoyancy may be efficiently obtained with the aid of westerlies. The flying object 10 may be operated at various altitudes in accordance with the operation purpose and type of the flying object 10.

Next, the ground unit will be described. The ground unit may be installed on the ground and is able to maintain the position of the flying object 10 and to receive the data observed by the flying object 10. According to the situations, it may supply electric power to the flying object 10. For this, the ground unit is connected through a wire unit “W” to the flying object 10.

The ground unit is provided one in number, and the ground unit is able to limit the position of the flying object 10 within a designated zone. If the wind speed is strong, the moving range of the flying object 10 may become wide, which inhibits stable mission operation. In order to improve the above problems, the flying object may equip with a horizontal wing 430 and a vertical wing 440.

Of course, the electric power accumulated through the wind power generation unit (not illustrated) of the flying object 10 may be supplied to the ground unit GU through the wire unit “W”.

For this, the ground unit GU may include a control unit; a data unit; and an electric power supply unit. Here, the data unit may store at least one more between the data of the flying object 10 and the data observed by the flying object 10. The electric power supply unit is configured to supply electric power to the flying object 10.

Meanwhile, the ground unit GU may further include a power source. This power source may allow to control the winder device which is provided to adjust the length of the wire unit “W”. The winder device is provided to adjust the tension of the wire unit “W” and may allow to wind or unwind the wire unit “W”, thus carrying out the tension adjustment.

Next, the wire unit “W” will be described. The wire unit “W” may include an electric power wire electrically connecting the flying object 10 and the ground unit; and a fixing wire which may extend together with the electric power wire.

The fixing wire may serve to prevent the flying object 10 from separating over a predetermined distance from the ground unit with the aid of tensional force. In the present embodiment of the present invention, it is formed of multiple strands of a high strength fiber material. It is obvious that the fixing wire may be made of a fiber material including a glass reinforced fiber or its synthetic fiber or may be made of various materials.

The fixing wire has over 900% in terms of its weight-to-tensional strength. For example, if the fixing wire having a diameter of 0.5 mm extends up to 20 km, about 45 kg to 75 kg of tensional strength may be provided to the flying object 10, whereupon the flying object 10 can be fixed within an enough range of buoyancy.

As not illustrated in the drawings, the wire unit “W” may equip with a current sensor unit. The current sensor unit may be intermittently provided multiple in number on the lengthwise direction of the wire unit “W”, thus carrying out a function to detect any short-circuit of the wire unit “W”. If the wire unit “W” having a very long length is short-circuit, the position of the short-circuit can be easily found out.

It is preferred that a reinforcing cover may be provided near at least a partial portion of the ground unit of the wire unit “W” in order to reinforce the strength of the wire unit “W” or the wire unit “W” may be configured in such a way that its thickness thickens, the configuration of which is designed to prevent any damage to the wire unit “W” due to collision with birds, etc.

Meanwhile, the flying object 10 may equip with a horizontal wing 430 and a vertical wing 440 so as to stably control the position of the flying object 10.

The flying object 10 may equip with the horizontal wing 430 and the vertical wing 440 are disposed rotatable about the rotation axes of the horizontal direction and the vertical direction. The rotations thereof are controlled by the driving controller of the control unit.

In other words, if the flying object 10 gets out of a designated zone in the upward and downward directions, the horizontal wing 430 forces the flying object 10 to stay within the designated zone in such a way to change the upward and downward resistances with respect to the wind of the flying object 10. If the flying object 10 gets out of the designated zone in the horizontal direction, the vertical wing 430 forces the flying object 10 to stay within the designated zone in such a way to change the leftward and rightward resistances with respect to the wind of the flying object 10.

Specifically, as illustrated in FIG. 14, if the flying object 10 descends below the designated zone (DZ), the GPS module provided in the control unit calculates the position of the flying object 10, and the driving controller detects that the position of the flying object 10 has deviated downward getting out of the designated zone based on a result of the calculation.

In this way, the calculation of the position of the flying object 10 is essentially necessary in order to control the position of the flying object 10. The position calculation of the flying object may be carried out in various ways. As mentioned above, the GPS module may be provided inside the flying object, thus calculating the position from the GPS module. The position of the flying object may be calculated by observing the flying object on the ground (control tower, etc.), and the calculated position information of the flying object may be transmitted to the control unit.

Otherwise, an observation unit formed of a camera, etc. may be provided so as to observe a topography and facilities on the ground, so the position of the flying object can be calculated from an observation result (topographical photo, photo showing a relative position with respect to a specific milestone, etc.) of the observation unit.

At this time, the distance to the ground may be calculated by further providing a radar measurement unit or a laser measurement unit, so the calculated distance may be applied together with the observation result of the observation unit, thus more accurately calculating the position.

Meanwhile, when the driving controller detects the same, the driving controller rotates the horizontal wing 430 in a horizontal state indicated by the dotted line, thus driving so that the upward lift with respect to the wind direction (indicated by the dotted line) can be generated.

To this end, the wind will move upwardly the flying object 10 with the aid of the friction with respect to the horizontal wing 430, so the flying object 10 can position within the designated zone.

Meanwhile, as illustrated in FIG. 15, if the flying object 10 gets out of the designated zone (DZ) in the horizontal direction, the driving controller detects the same and rotates the vertical wing 440, thus guiding the flying object into the designated zone.

Next, the configuration and function of the flying object system according to a ninth exemplary embodiment of the present invention will be described.

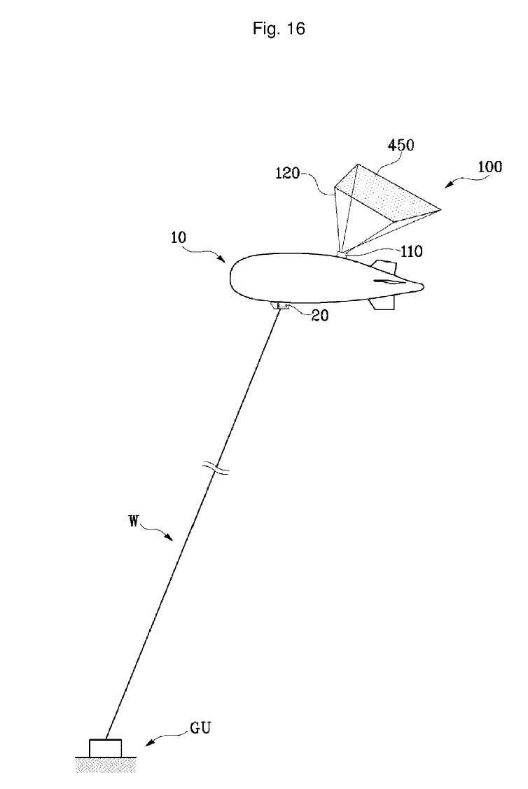

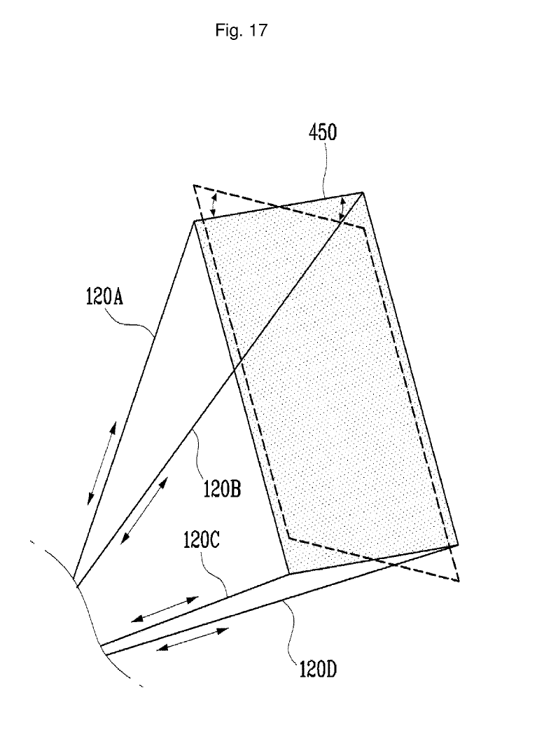

FIG. 16 is a schematic view illustrating a configuration of a flying object operating system according to a ninth exemplary embodiment of the present invention. FIG. 17 is an example view illustrating an operation state of a buoyancy-generation unit of a flying object operating system according to a ninth embodiment of the present invention.

As illustrated in FIG. 16, the flying object operating system according to a ninth exemplary embodiment of the present invention may include, but is not limited to, a flying object 10; a ground unit GU and a wire unit “W” and further includes a buoyancy-generation unit 100.

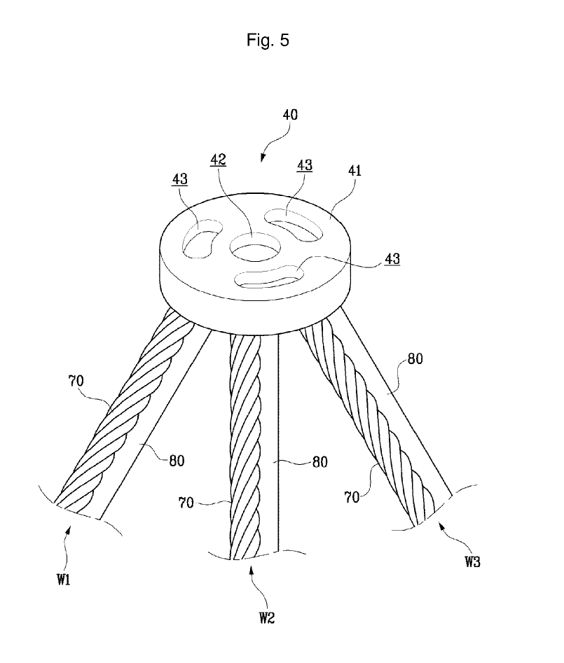

The buoyancy-generation unit 100 may be provided on one side of the flying object 10 so as to generate buoyancy with the aid of friction with air. As illustrated in FIG. 5, the buoyancy-generation unit 100 is formed of a friction unit 450 having a surface wide enough to make a friction with air and may be formed in a kite shape.

More specifically, the buoyancy-generation unit 100 may include a base unit 110 fixed at one side of the flying object 10; a plurality of connection cables 120 an end of each of which is fixed at the base unit 110; and a friction unit 450 which is connected to the connection cable 120 and has a friction with air and separates from the flying object, thus generating buoyancy.

Meanwhile, a plurality of though holes passing through the friction unit 450 may be formed on the friction unit 450. It is possible to prevent the connection cable 120 from being cut due to over buoyancy which will apply to the friction unit 450.

In addition, the base unit 110 may include a winder (not illustrated) at a fixing portion of each of the connection cables 120, thus adjusting the length of the connection cable 120.

The friction angle with air may be adjusted by adjusting the length of a part of the connection cables 120 connected to the friction unit 450, whereupon the position of the flying object 10 can be controlled in the above way.

More specifically, as illustrated in FIG. 17, the lengths of the connection cables 120 fixed at the ends of the friction unit 450 can be adjusted different from each other. For example, as illustrated in FIG. 17, if the flying object 10 is out of the designated zone (DZ) in the downward direction, the connection cables 120A and 1208 of the tops among the connection cables are wound relatively short, and for this the upward lift can be generated with the friction force with respect to the wind, whereupon the flying object 10 can move upward, and the position of the flying object 10 can be corrected to be within the designated zone (DZ).

In the same way, in order to generate the drag in the leftward and rightward directions, the drag is forced to generate leftward or rightward by relatively adjusting the lengths of the connection cables 120A and 120C of one side and of the connection cables 1208 and 120D of the other side.

Next, the configuration and function of the flying object operating system according to a tenth exemplary embodiment of the present invention will be described

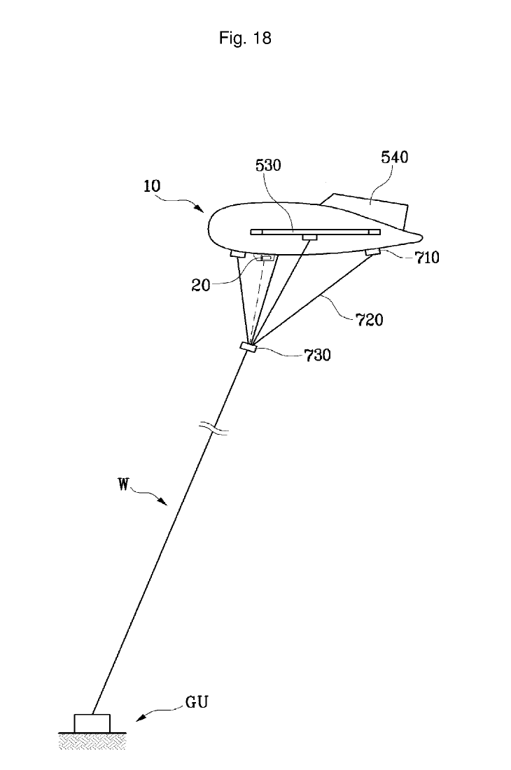

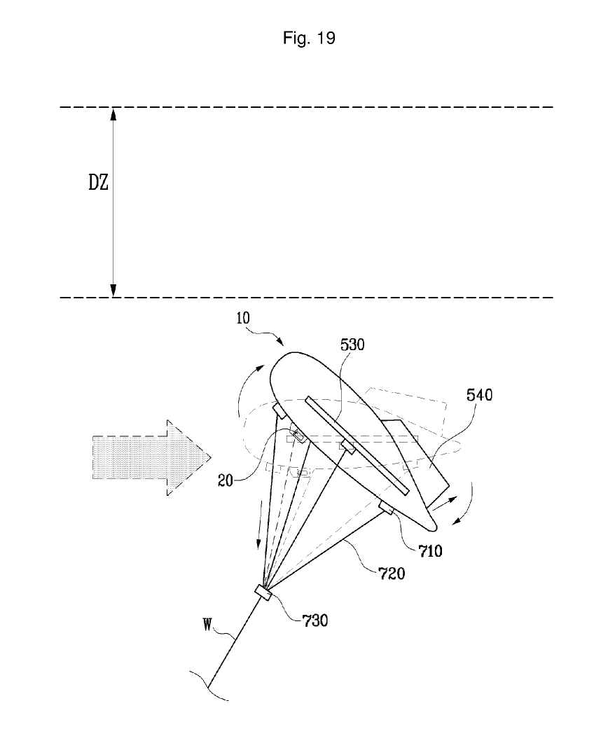

FIG. 18 is a schematic view illustrating a configuration of a flying object operating system according to a tenth exemplary embodiment of the present invention. FIG. 19 is an example view illustrating an operation state of a position control of a flying object operating system according to a tenth exemplary embodiment of the present invention.

As illustrated in FIG. 18, the flying object operating system according to a tenth exemplary embodiment of the present invention may include, but is not limited to, a flying object 10; a ground unit GU; and a wire unit “W”.

At this time, as illustrated in the drawings, the flying object 10 may include a horizontal wing 530; and a vertical wing 540. The horizontal wing 530 and the vertical wing 540 are arranged fixed at the flying object 10, and it is preferred that they are larger than those in the first exemplary embodiment of the present invention for the sake of enhanced position control.

In addition, a branching unit 630 is provided at an end of the flying object 10 of the wire unit “W”, and a plurality of adjusting wires 620 branch from the branching unit 630 and are engaged to multiple portions of the flying object 10.

The branching unit 630 is a member for engaging the adjusting wires 620 and the wire unit “W”, and the adjusting wire 620 is a member, which is engaged to the spaced-apart portion of the flying object 10, for adjusting the drag direction with respect to the wind of the flying object 10 through the length adjustment.

For this, the adjusting wire 620 is engaged with a driving engaging unit 610 provided at each portion of the flying object 10.

The driving engaging unit 610 includes a winder (not illustrated) in its inside and is able to wind and unwind the adjusting wire 620 in accordance with a control command of the driving controller, thus adjusting the length of the adjusting wire 620.

Here, the driving engaging unit 610 is a member to which the adjusting wire 620 is engaged. It is preferred that the driving engaging unit 610 is provided on an outer surface of the flying object 10 in a state where the spaced-apart distance between them is maximally longest in terms of the position control efficiency of the flying object 10. It is advantageous that the driving engaging unit 610 is provided four in number for the sake of controls in more than four directions.

FIG. 18 is an example view illustrating a configuration wherein the driving engaging unit 610 is arranged widely spaced-apart from each other in the four directions, namely, forward, backward, leftward and upward directions of the flying object.

An example wherein the flying object operating system according to a tenth exemplary embodiment of the present invention controls the position will be described with reference to FIG. 19

As illustrated in FIG. 19, if the flying object 10 descends below the designated zone (DZ), the GPS module provided at the control unit calculates the position of the flying object 10, and the driving controller may detect that the position of the flying object 10 has deviated downward out of the designated zone (DZ) based on the calculation result.

When the driving control detects it, the driving controller drives the driving engaging unit 610 provided on a front side of the flying object 10 to wind the adjusting wire 620, whereupon the length of the adjusting wire 620 is decreased, and the driving engaging unit 610 provided on a rear side of the flying object 10 is driven to increase the length by unwinding the adjusting wire 620.

The shape of the flying object 10 may change in a state where the front side indicated by the line is lifted up in a horizontal state indicated by the dotted line in accordance with the driving of the driving engaging unit 610. To this end, the drag with respect to the wind generating in the flying object 10 may generate in the direction where the flying object 10 is moved upward, whereupon the flying object 10 ascends so that the flying object 10 positions within the designated zone (DZ).

The right of the present invention is not limited to the so-far descried exemplary embodiments, but may be defined by the scope of the claims. It is obvious that a person having ordinary skill in the art may variously change or modify within the scopes of the claims.

For example, it is not necessary that the gas is filled in the inside of the flying object 10. The flying object 10 may receive buoyancy using the buoyancy-generation unit 100. In this case, the flying object 10 may be changed into various shapes.

### INDUSTRIAL APPLICABILITY

The present invention is directed to a system for operating a flying object which is floating in the air above the ground. The present invention is industrially advantageous in the way that the position control is available autonomously, so the flying object can be stably fixed within a mission operation zone while using a single wire, thus obtaining stability for a flying object mission operation.

1. A flying object operating system, comprising:
a flying object which is floating in the air above the ground;
at least two or more ground units which are installed on the ground; and
a wire unit which is provided for each ground unit, wherein one end of the wire unit is fixed at the ground unit, and the other end is fixed at the flying object, interconnecting the ground unit and the flying object,
wherein the ground units are installed spaced-apart from each other by a predetermined interval, each of the ground unit and the wire unit are provided two in number, and each of the wire units separately includes two electric power cables.

2. A flying object operating system, comprising:
a flying object which is floating in the air above the ground;
at least two or more ground units which are installed on the ground; and
a wire unit which is provided for each ground unit, wherein one end of the wire unit is fixed at the ground unit, and the other end is fixed at the flying object, thus interconnecting the ground unit and the flying object,
wherein the ground units are installed spaced-apart from each other by a predetermined interval, each of the ground unit and the wire unit are provided three in number, and each of the wire units separately includes an electric power cable and a ground cable.

3. A flying object operating system, comprising:
a flying object which is floating in the air above the ground;
at least two or more ground units which are installed on the ground; and
a wire unit which is provided for each ground unit, wherein one end of the wire unit is fixed at the ground unit, and the other end is fixed at the flying object, thus interconnecting the ground unit and the flying object,
wherein the ground units are installed spaced-apart from each other by a predetermined interval, each of the ground unit and the wire unit are provided three in number, and each of the wire units separately includes three-phase electric power cables.

4. The system of claim 1, further comprising:
a buoyancy-generation unit which is provided on one side of the flying object and is able to generate buoyancy with the aid of flow of gas and transfer the buoyancy to the flying object.

5. The system of claim 4, wherein the buoyancy-generation unit comprises:
a base unit which is fixed on one side of the flying object;
at least one or more connection cable which is fixed at the base unit; and
a friction unit which is connected with the connection cable and has a friction with air and is able to generate buoyancy while separating from the flying object.

6. The system of claim 5, wherein the flying object comprises a plurality of the buoyancy-generation units, and as a part of a plurality of the buoyancy-generation units operates, the direction of the buoyancy generated by the buoyancy-generation unit is adjusted.

7. The system of claim 6, wherein the connection cable of the buoyancy-generation unit is provided multiple in number, and a winder is provided at an end of each connection cable, thus adjusting the length of each connection cable, and the direction of friction with air in the friction unit can be adjusted by adjusting the length of at least a part of a plurality of the connection cables.

8. The system of claim 7, wherein the connection cable is configured in such a way to adjust the length of the connection cable, and the height where the friction unit is floating from the flying object can be adjusted using the connection cable, thus selectively driving the buoyancy-generation unit.

9. The system of claim 8, wherein the friction unit of the buoyancy-generation unit is provided multiple in number, and a plurality of the friction units are provided in a row on the tops of the closely neighboring other friction units.

10. The system of claim 5, wherein the flying object operates at an altitude of 2 km˜12 km.

11. The system of claim 4, wherein the flying object further comprises a wind power generation unit which is able to generate electric power through friction with air.

12. The system of claim 11, wherein the wind power generation unit comprises:
a main body which is provided on one side of the flying object and includes a power generation unit in its inside; and a blade which is provided at an end of a fixing unit and rotates during the friction with air.

13. The system of claim 12, wherein the wind power generation unit is provided rotatable on the flying object, whereupon the friction angle between the blade and air can be adjusted.

14. The system of claim 13, wherein the flying object includes a sensor which is able to measure the angle of friction with air and wind power.

15. The system of claim 14, wherein the wire unit comprises:
an electric power wire for electrically connecting the flying object and the ground unit; and a fixing wire which extends together with the electric power wire and is able to prevent the flying object from separating by over a predetermined distance from the ground unit with the aid of tensional force.

16. The system of claim 15, wherein the ground unit comprises:
a main ground; and
a sub-ground which is installed spaced apart from the main ground and is installed on at least one position of the ground,
wherein an electric power supply unit is provided at either the main ground or the sub-ground so as to supply electric power to the flying object.

17. The system of claim 16, wherein the ground unit comprises:
a main ground; and
a pair of sub-grounds which are spaced apart from the main ground,
wherein the main ground and a pair of the sub-grounds are installed at a vertex of a virtually drawn regular triangle or an isosceles triangle.

18. The system of claim 17, wherein the wire unit includes an observation device, and the observation device is arranged movable along the wire unit.

19. The system of claim 1, wherein the ground unit includes a winder device to adjust the tension of the wire unit.

20. A flying object operating system which is directed to operating a flying object so as to carry out a communication relay function or an observation function in such a way to maintain a floating state within a designated zone above the ground, comprising:
a flying object which is floating in the air;
a ground unit which is installed on the ground; and
a wire unit one end of which is fixed at the ground unit and the other end of which is fixed on the flying object while interconnecting the ground unit and the flying object,
wherein the flying object includes:
a horizontal wing which is arranged rotatable with respect to the flying object and allows the flying object to stay within a designated zone by changing the upward and downward resistances with respect to the wind of the flying object if the flying object deviates out of the designated zone in the upward and downward directions;
a vertical wing which is arranged rotatable with respect to the flying object and allows the flying object to stay within the designated zone by changing the leftward and rightward resistances with respect to the wind of the flying object if the flying object deviates out of the designated zone in the horizontal direction; and
a control unit which detects the position of the flying object and is able to control the rotations of the horizontal wing and the vertical wing in accordance with the detected position.

21. The system of claim 20, wherein the control unit comprises:
a GPS module for detecting the position of the flying object; and
a driving controller which is configured to drive any one of the horizontal wing and the vertical wing by determining whether or not the detection position of the GPS module is within the set designated zone and the separating direction and distance from the designated zone.

22. The system of claim 20, wherein the control unit is configured to recognize the position of the flying object from the position information which is observed on the ground and is transmitted thereto.

23. The system of claim 20, wherein the control unit includes:
an observation unit for observing a topography and facilities on the ground; and
a position calculation unit which is able to calculate the position of the flying object based on a result of the observation carried out by the observation unit.

24. The system of claim 20, wherein the control unit further includes a radar measurement unit, and the position calculation unit calculates the position of the flying object based on a result of the observation by the observation unit and a result of the measurement by the radar measurement unit.

25. The system of claim 20, wherein the control unit further includes a laser measurement unit, and the position calculation unit calculates the position of the flying object based on a result of the observation by the observation unit and a result of the measurement by the laser measurement unit.

26. A flying object operation system, comprising:
a flying object which is floated in the air above the ground;
a ground unit which is installed on the ground;
a wire unit one end of which is fixed at the ground unit, and the other end of which is fixed on the flying object, thus interconnecting the ground unit and the flying object; and
a buoyancy-generation unit which is provided on one side of the flying object and is able to generate buoyancy with the aid of the flow of gas and transfer the buoyancy to the flying object,
wherein the buoyancy-generation unit comprises:
a friction unit which has a friction with air and separates from the flying object, thus generating buoyancy;
a plurality of connection cables one end of each of which is connected with the friction unit; and
a base unit which is provided on one side of the flying object for the other end of each of the connection cables to be fixed, thus adjusting the lengths of the connection cables.

27. The system of claim 26, wherein the flying object further includes a control unit which is configured to detect the position of the flying object and control the base unit to adjust the lengths of the connection cables based on the detected position.

28. The system of claim 27, wherein the control unit includes:
a GPS module for detecting the position of the flying object; and
a driving controller which drives the winder provided at the base unit by determining whether or not the detection position of the GPS module is within a designated zone and the separating direction and distance of the designated zone.

29. The system of claim 27, wherein the control unit is able to recognize the position of the flying object from the position information observed on the ground and transferred thereto.

30. The system of claim 27, wherein the control unit includes:
an observation unit for observing a topography and facilities on the ground; and
a position calculation unit which is able to calculate the position of the flying object from a result of the observation by the observation unit.

31. The system of claim 27, wherein the control unit further includes a radar measurement unit, and the position calculation unit calculates the position of the flying object from a result of the observation by the observation unit and a result of the measurement by the radar measurement unit.

32. The system of claim 27, wherein the control unit further includes a laser measurement unit, and the position calculation unit calculates the position of the flying object from a result of the observation by the observation unit and a result of the measurement by the laser measurement unit.

33. A flying object operation system, comprising:
a flying object which is floated in the air above the ground;
a ground unit which is installed on the ground;
a wire unit one end of which is fixed at the ground unit;
a plurality of adjusting wires one end of each of which is fixed at the other end of the wire unit, and the other end of each of which is fixed at the flying object; and
a driving engaging unit which is provided on one side of the flying object and is engaged with the adjusting wire, thus fixing the adjusting wire at the flying object in such a way that the length of the adjusting wire is adjustable,
wherein the flying object includes: a horizontal wing and a vertical wing which are provided in the horizontal and vertical directions of the flying object.

34. The system of claim 33, wherein the flying object further comprises a control unit which detects the position of the flying object and controls the driving engaging unit so as to adjust the length of the adjusting wire based on the detected position.

35. The system of claim 34, wherein the control unit comprises:
a GPS module for detecting the position of the flying object; and
a driving controller which drives a winder provided at the driving engaging unit by determining whether or not the detection position of the GPS module is within the set designated zone and the separating direction and distance of the designated zone.

36. The system of claim 34, wherein the control unit is able to recognize the position of the flying object from the position information observed on the ground and transferred thereto.

37. The system of claim 34, wherein the driving engaging unit is installed four in number at the left, back, left and right sides of the flying object.

38. The system of claim 20, wherein the designated zone is a limited range of the position of the flying object so as to stably carry out the function of the flying object.

39. The system of claim 20, wherein the flying object comprises at least one or more solar panel or wind power generation unit so as to self-generate power which will be used when operating the flying object.

40. The system of claim 20, wherein the wire unit includes an electric power cable and a ground cable for supplying electric power to the flying object.

41. The system of claim 20, wherein the ground unit is provided multiple in number which are spaced apart from each other at regular intervals, thus extending and supporting the flying object in different directions, and the wire unit includes either the electric cable or the ground cable.

42. The system of claim 41, wherein each of the ground unit and the wire unit is provided two in number, and each of the wire units separately includes two electric power cables.

43. The system of claim 41, wherein each of the ground unit and the wire unit is provided three in number, and each of the wire units separately includes an electric power cable and a ground cable.

44. The system of claim 41, wherein each of the ground unit and the wire unit is three in number, and each of the wire units separately includes three-phase electric power cables.
